(19) United States
(12) Patent Application Publication
(10) Pub. No.: US 2011/0193762 A1
(43) Pub. Date: Aug. 11, 2011

(54) GROUND RADIATION ANTENNA

(75) Inventors: Hyeng-cheul CHOI, Seoul (KR); Jaeseok Lee, Seoul (KR); Oul Cho, Suwon-si (KR); Hyungjin Lee, Ansan-si (KR); Bumki Park, Seoul (KR)

(73) Assignee: RADINA CO., LTD., Seoul (KR)

(21) Appl. No.: 13/081,014

(22) Filed: Apr. 6, 2011

Related U.S. Application Data
(63) Continuation of application No. PCT/KR2010/009338, filed on Dec. 24, 2010.

(30) Foreign Application Priority Data
Feb. 11, 2010 (KR) 10-2010-0012775
Apr. 9, 2010 (KR) 10-2010-0032922
May 7, 2010 (KR) 10-2010-0043186
May 7, 2010 (KR) 10-2010-0043189
May 7, 2010 (KR) 10-2010-0043190
Jun. 14, 2010 (KR) 10-2010-0056207
Dec. 23, 2010 (KR) 10-2010-0133919

(51) Int. Cl. H01Q 1/48

(52) U.S. Cl. 343/848

(57) ABSTRACT

A ground radiation antenna is disclosed. Herein, the ground radiation antenna provides a radiator-forming circuit, which is formed to have a simple structure using a capacitive element, as well as a feeding circuit suitable for the provided radiator-forming circuit. Thus, the structure of the antenna becomes simpler and the size of the antenna becomes smaller. Accordingly, the fabrication process of the antenna is simplified, thereby largely reducing the fabrication cost.

### BACKGROUND OF THE INVENTION

1. Field of the Invention

The present invention relates to an antenna and, more particularly, to a ground radiation antenna using ground radiation of a wireless communication terminal.

2. Related Art Technology

An antenna is a device that receives RF signals from air into a wireless communication terminal or transmits RF signals from a wireless communication terminal to air. In other words, the antenna is an essential element used in wireless communication. Recently, the mobile telecommunication terminals are required to be compact in size, lightweight, and equipped with a slimmer antenna structure. Also, as the data size being transmitted and received through wireless communication has become larger, mobile telecommunication terminals need antennas providing greater performance.

Accordingly, the ground radiation antenna has been proposed to meet such demands. Herein, the ground radiation antenna uses the ground to radiate RF signals. More specifically, a radiator of a related art antenna is provided with a separate radiator occupying a large volume inside or outside of the mobile telecommunication terminal. However, by using the ground as the radiator, the ground being essentially provided in a wireless communication terminal, the size of the antenna may be largely reduced in the ground radiation antenna.

However, even in the ground radiation antenna, the radiator cannot be fully functional by using only the ground. Therefore, the ground radiation antenna is additionally provided with a separate radiating element, which performs the role of the radiator along with the ground.

Accordingly, the related art ground radiation antenna is disadvantageous in that, due to the radiating element having a large volume and a complex structure, the size of the ground radiation antenna became larger, and the fabrication process of the antenna became very complex.

### SUMMARY OF THE INVENTION

### Object of the Invention

An object of the present invention is to provide a ground radiation antenna having a remarkably simple structure and also showing an excellent radiating performance.

### Technical Solutions of the Invention

Based upon the characteristics of the ground antenna itself, the present invention provides a radiator-forming circuit using a capacitive element that can replace the radiating element having a complex structure.

Additionally, the present invention also provides a feeding scheme that can maximize the radiating performance, while having a simple structure.

As described above, by fabricating an antenna using a radiator-forming circuit and a feeding circuit each having a noticeably simplified structure, the present invention provides an antenna that is smaller in size and that shows an excellent radiating performance.

### Effect of the Invention

The ground radiation antenna according to the present invention is advantageous in that the antenna is configured of an extremely simple structure, thereby being capable of reducing the size of the antenna.

Also, due to its simple structure, the ground radiation antenna according to the present invention may simplify the fabrication process, thereby being capable of reducing the fabrication cost to a remarkable level.

Furthermore, the ground radiation antenna according to the present invention may have the characteristics of a broad-band and a multi-band and may provide users with an excellent radiation performance.

### BRIEF DESCRIPTION OF THE DRAWINGS

FIG. 1 illustrates an antenna using ground radiation according to a first embodiment of the present invention;

FIG. 2 illustrates an antenna using ground radiation according to a second embodiment of the present invention;

FIG. 3 illustrates an antenna using ground radiation according to a third embodiment of the present invention;

FIG. 4 illustrates an antenna using ground radiation according to a fourth embodiment of the present invention;

FIG. 5 illustrates an antenna using ground radiation according to a fifth embodiment of the present invention;

FIG. 6 illustrates an antenna using ground radiation according to a sixth embodiment of the present invention;

FIG. 7 illustrates an antenna using ground radiation according to a seventh embodiment of the present invention; and

FIG. 8 illustrates an antenna using ground radiation according to an eighth embodiment of the present invention.

### DETAILED DESCRIPTION OF THE INVENTION

In the related art antenna, efforts were made to enhance the radiation performance by separately equipping the antenna with a radiating element for ground radiation, and by varying the formation or structure of the radiating element. More specifically, efforts were made for realizing a radiator by combining an element having both inductance and capacitance with a capacitor and an inductor.

However, the applicant was able to discover that an excellent ground radiating element could be fabricated when using the inductance of the ground, by simply connecting the capacitor to the ground, without having to use a separate element configured of a complex structure.

In order to function as the radiating element of the antenna, the capacitor having the capacitance and the inductor having the inductance should both exist so as to create a resonance. The application also discovered that, since the ground provides the inductance required to generate the resonance, only the capacitor and the ground were required to perform the function of the radiating element without separate elements for providing the inductance.

However, the related art ground radiators were incapable of efficiently using the inductance provided from the ground. And, accordingly, efforts were made in the related art in trying to generate resonance by configuring elements having a complex structure and being provided with both capacitance and inductance.

Conversely, according to the present invention, by being capable of efficiently using the inductance provided from the ground itself, a radiator having a simple structure may be configured to connect the capacitor to the ground, and an antenna using the above-described radiator may be provided.

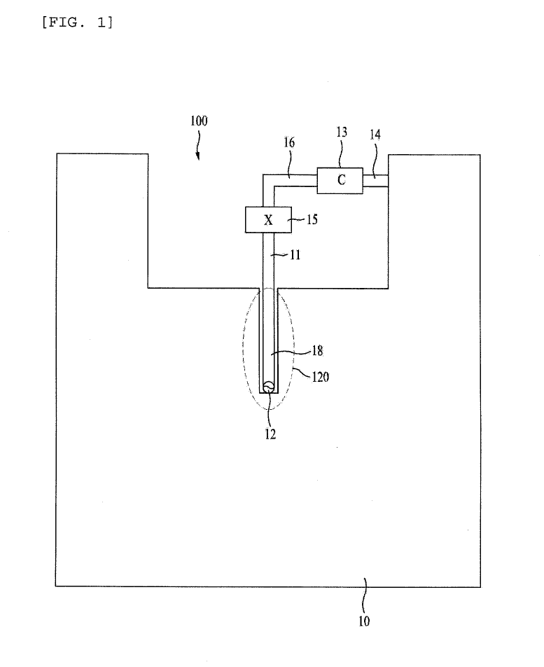

FIG. 1 illustrates an antenna using ground radiation according to a first embodiment of the present invention.

Referring to FIG. 1, the antenna using ground radiation according to the first embodiment of the present invention includes a feeding part 120 configured of a feeding source 12 and a feeding transmission line 18, a ground 10, a first conductor line 11, an element 15, a second conductor line 16, a capacitive element 13, and a third conductor line 14.

The ground 10 provides a reference voltage inside a telecommunication device, such as a mobile communication user terminal. Generally, it is preferable that a user terminal ground is formed in a printed circuit board (PCB), wherein circuit devices required for the operation of the user terminal are combined with one another. According to the present invention, in addition to providing the reference voltage, the ground 10 also performs the function of a ground radiator of the antenna. This characteristic is equally applied to the other embodiments of the present invention, which will be described in detail later on.

According to the first embodiment of the present invention, the feeding part 120, the first conductor line 11, the element 15, the second conductor line 16, the capacitive element 13, and the third conductor line 14 collectively operate as a feeding circuit for exciting the antenna, so that radiation of an RF signal can occur through the antenna radiator. Additionally, the first conductor line 11, the element 15, the second conductor line 16, the capacitive element 13, and the third conductor line 14 operate as an antenna radiator-forming circuit, which enables the RF signal to be actually radiated. More specifically, according to the first embodiment of the present invention, the first conductor line 11, the element 15, the second conductor line 16, the capacitive element 13, and the third conductor line 14 not only correspond to portions of the feeding circuit of the antenna but also correspond to portions of a radiator-forming circuit.

According to the first embodiment of the present invention, the element 15 may correspond to an inductive element, a capacitive element, or a simple conductive line.

According to the first embodiment of the present invention, the feeding part 120 is configured of a coplanar waveguide (CPW). However, in addition to the CPW, a variety of other types of feeding part may be configured in the present invention. Such characteristic is equally applied to the other embodiments of the present invention.

According to the first embodiment of the present invention, the feeding circuit is configured inside of a clearance area 100. The clearance area 100 corresponds to an area within the user terminal ground 10 having a portion of the ground removed therefrom.

According to the first embodiment of the present invention, it is preferable that the capacitive element corresponds to a lumped circuit element, such as a chip capacitor. However, in addition to the chip capacitor, a capacitive element having a general capacitive structure may also be used in the first embodiment of the present invention. Furthermore, the capacitive element may either be configured of a single capacitor, or may be configured by connecting two or more capacitors to one another.

Meanwhile, according to the first embodiment of the present invention, in order to obtain a specific capacitance, the capacitive element 13 may use a combination of multiple elements. For example, the capacitive element 13 may be replaced with a combined structure of a capacitive element and an inductive element.

Furthermore, in the other embodiments of the present invention that will be described hereinafter, in order to obtain a specific capacitance, the capacitive element may use a combination of multiple elements. For example, the capacitive element may be replaced with a combined structure of a capacitive element and an inductive element.

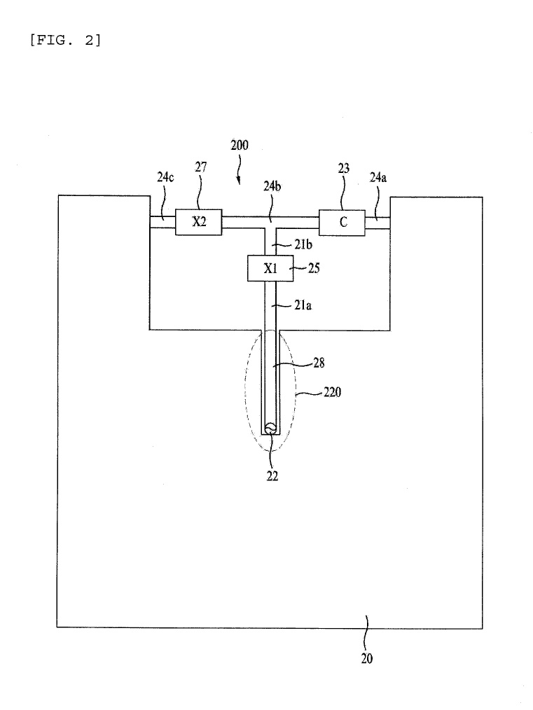

FIG. 2 illustrates an antenna using ground radiation according to a second embodiment of the present invention.

Referring to FIG. 2, the antenna using ground radiation according to the second embodiment of the present invention includes a feeding part 220 configured of a feeding source 22 and a feeding transmission line 28, a ground 20, a first conductor line 21a, a first element 25, a second conductor line 21b, a capacitive element 23, a third conductor line 24a, a fourth conductor line 24b, a second element 27, and a fifth conductor line 24c.

Herein, the feeding part 220, the first conductor line 21a, the first element 25, the second conductor line 21b, the fourth conductor line 24b, the capacitive element 23, and the third conductor line 24a collectively operate as a feeding circuit for exciting the antenna, so that radiation of an RF signal can occur through the antenna radiator. Furthermore, the first conductor line 21a, the first element 25, the second conductor line 21b, the fourth conductor line 24b, the capacitive element 23, and the third conductor line 24a operate in collaboration (or collectively) as an antenna radiator-forming circuit, which enables the RF signal to be actually radiated. More specifically, according to the second embodiment of the present invention, the first conductor line 21a, the first element 25, the second conductor line 21b, the fourth conductor line 24b, the capacitive element 23, and the third conductor line 24a not only correspond to portions of the feeding circuit of the antenna but also correspond to portions of a radiator-forming circuit.

Meanwhile, the fifth conductor line 24c and the second element 27 correspond to elements that are added in order to facilitate impedance matching of the first embodiment of the present invention.

According to the second embodiment of the present invention, the first element 25 may correspond to an inductive element, a capacitive element, or a simple conductive line. And, the second element 27 may correspond to an inductive element or a simple conductive line.

According to the second embodiment of the present invention, the feeding circuit is configured inside of a clearance area 200. The clearance area 200 corresponds to an area within the user terminal ground 20 having a portion of the ground removed therefrom.

According to the second embodiment of the present invention, it is preferable that the capacitive element corresponds to a lumped circuit element, such as a chip capacitor. However, in addition to the chip capacitor, a capacitive element having a general capacitive structure may also be used in the second embodiment of the present invention. Furthermore, the capacitive element may either be configured of a single capacitor, or may be configured by connecting two or more capacitors to one another.

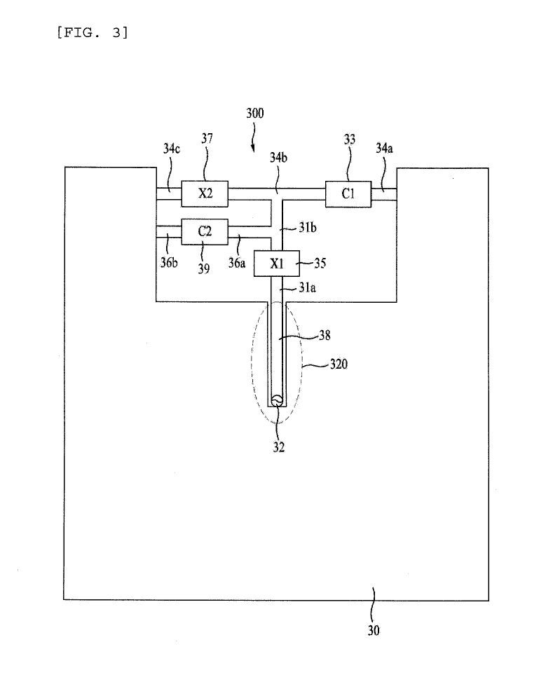

FIG. 3 illustrates an antenna using ground radiation according to a third embodiment of the present invention.

Referring to FIG. 3, the antenna using ground radiation according to the third embodiment of the present invention includes a feeding part 320 configured of a feeding source 32 and a feeding transmission line 38, a ground 30, a first conductor line 31a, a first element 35, a second conductor line 31b, a first capacitive element 33, a third conductor line 34a, a fourth conductor line 34b, a second element 37, a fifth conductor line 34c, a sixth conductor line 36a, a second capacitive element 39, and a seventh conductor line 36b.

Herein, the feeding part 320, the first conductor line 31a, the first element 35, the second conductor line 31b, the fourth conductor line 34b, the first capacitive element 33, and the third conductor line 34a collectively operate as a first feeding circuit for exciting the antenna, so that radiation of an RF signal can occur through the antenna radiator.

Also, the first conductor line 31a, the first element 35, the second conductor line 31b, the fourth conductor line 34b, the first capacitive element 33, and the third conductor line 34a operate in collaboration (or collectively) as a first antenna radiator-forming circuit, which enables the RF signal to be actually radiated.

More specifically, according to the third embodiment of the present invention, the first conductor line 31a, the first element 35, the second conductor line 31b, the fourth conductor line 34b, the first capacitive element 33, and the third conductor line 34a not only correspond to portions of the feeding circuit of the antenna but also correspond to portions of a radiator-forming circuit.

Additionally, the feeding part 320, the first conductor line 31a, the first element 35, the second conductor line 31b, the sixth conductor line 36a, the second capacitive element 39, and the seventh conductor line 36b collectively operate as a second feeding circuit for exciting the antenna, so that radiation of an RF signal can occur through the antenna radiator.

Also, the first conductor line 31a, the first element 35, the second conductor line 31b, the sixth conductor line 36a, the second capacitive element 39, and the seventh conductor line 36b operate in collaboration (or collectively) as a second antenna radiator-forming circuit, which enables the RF signal to be actually radiated.

More specifically, according to the third embodiment of the present invention, the first conductor line 31a, the first element 35, the second conductor line 31b, the sixth conductor line 36a, the second capacitive element 39, and the seventh conductor line 36b not only correspond to portions of the feeding circuit of the antenna but also correspond to portions of a radiator-forming circuit.

The antenna according to the third embodiment of the present invention may realize a multi-band characteristic due to a double antenna radiator-forming circuit.

Meanwhile, the fifth conductor line 34c and the second element 37 correspond to elements that are added in order to facilitate impedance matching.

According to the third embodiment of the present invention, the first element 35 may correspond to an inductive element, a capacitive element, or a simple conductive line. And, the second element 37 may correspond to an inductive element or a simple conductive line.

According to the third embodiment of the present invention, the feeding circuit is configured inside of a clearance area 300. The clearance area 300 corresponds to an area within the user terminal ground 30 having a portion of the ground removed therefrom.

According to the third embodiment of the present invention, it is preferable that the capacitive element corresponds to a lumped circuit element, such as a chip capacitor. However, in addition to the chip capacitor, a capacitive element having a general capacitive structure may also be used in the third embodiment of the present invention. Furthermore, the capacitive element 13 may either be configured of a single capacitor, or may be configured by connecting two or more capacitors to one another.

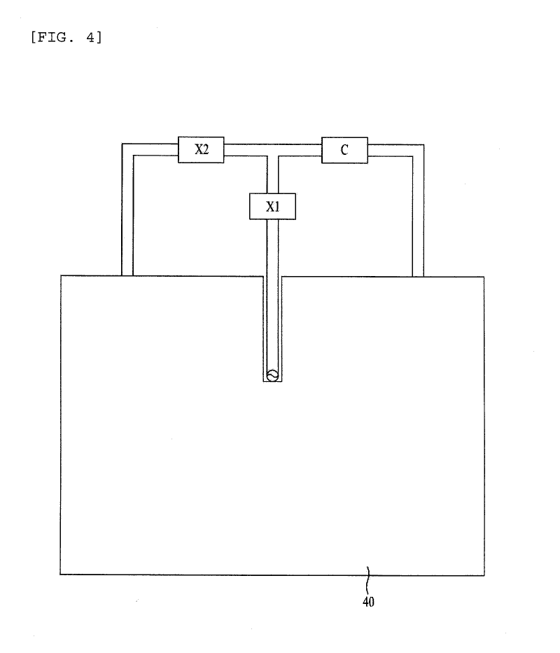

FIG. 4 illustrates an antenna using ground radiation according to a fourth embodiment of the present invention.

Although the antenna according to the fourth embodiment of the present invention has the same structure as the antenna according to the second embodiment of the present invention, a separate clearance is not formed in the antenna according to the fourth embodiment of the present invention. Furthermore, the antenna according to the fourth embodiment of the present invention is configured in an area that is not surrounded by the ground.

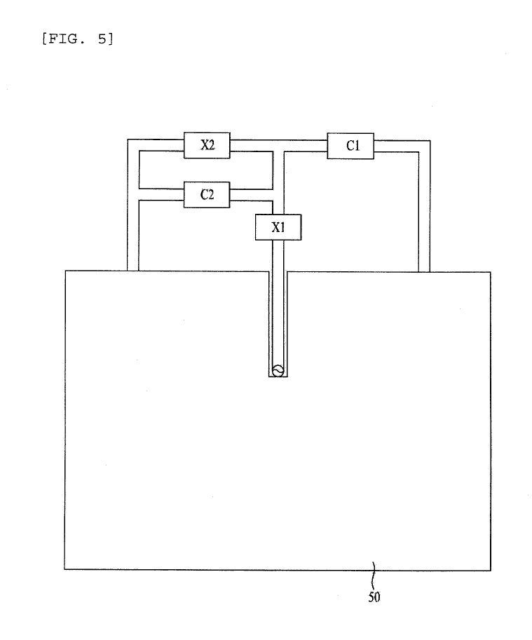

FIG. 5 illustrates an antenna using ground radiation according to a fifth embodiment of the present invention.

Although the antenna according to the fifth embodiment of the present invention has the same structure as the antenna according to the third embodiment of the present invention, a separate clearance is not formed in the antenna according to the fifth embodiment of the present invention. Furthermore, the antenna according to the fifth embodiment of the present invention is configured in an area that is not surrounded by the ground.

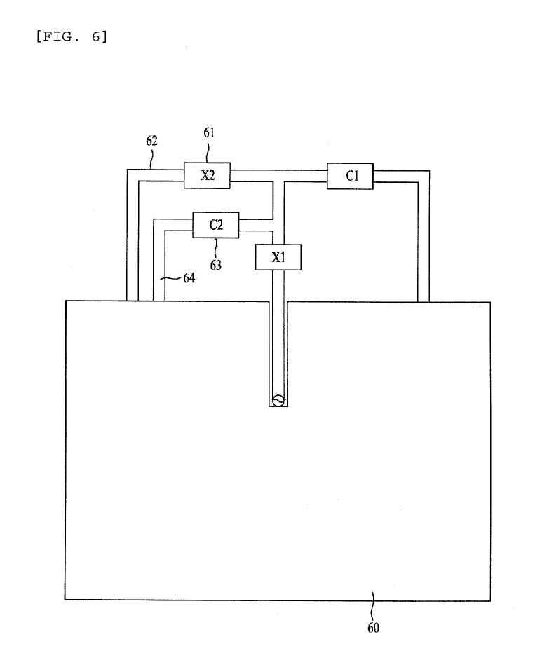

FIG. 6 illustrates an antenna using ground radiation according to a sixth embodiment of the present invention.

Just as the antenna according to the fifth embodiment of the present invention, although the antenna according to the sixth embodiment of the present invention has the same basic structure as the antenna according to the third embodiment of the present invention, a separate clearance is not formed in the antenna according to the sixth embodiment of the present invention. Furthermore, the antenna according to the sixth embodiment of the present invention is configured in an area that is not surrounded by the ground.

However, unlike in the fifth embodiment of the present invention, in the antenna according to the sixth embodiment of the present invention, the capacitance element 63 is directly connected to the ground 60, and the capacitance element 63 does not meet with the conductor line 62, which connects the element 61 and the ground 60.

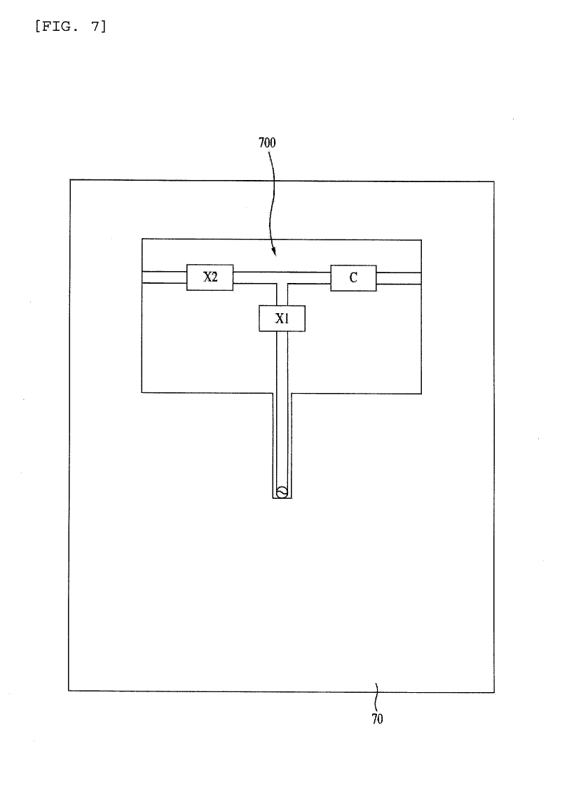

FIG. 7 illustrates an antenna using ground radiation according to a seventh embodiment of the present invention.

Although the antenna according to the seventh embodiment of the present invention has the same basic structure as the antenna according to the second embodiment of the present invention, the shape of the clearance is different from the antenna according to the second embodiment of the present invention.

More specifically, the clearance of the antenna according to the second embodiment of the present invention has three sides surrounded by the ground, and only one side of the clearance is open. However, the clearance 700 of the antenna according to the seventh embodiment of the present invention is formed to have all four sides surrounded by the ground 70.

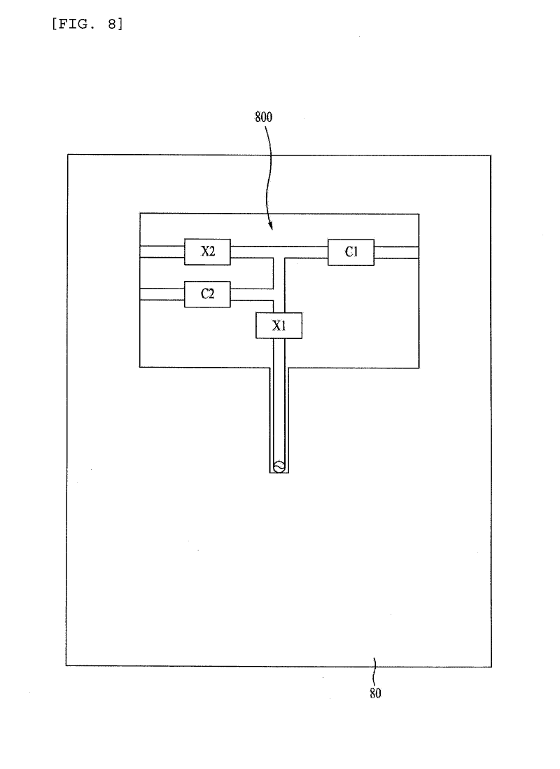

FIG. 8 illustrates an antenna using ground radiation according to an eighth embodiment of the present invention.

Although the antenna according to the eighth embodiment of the present invention has the same basic structure as the antenna according to the third embodiment of the present invention, the shape of the clearance is different from the antenna according to the third embodiment of the present invention.

More specifically, the clearance of the antenna according to the third embodiment of the present invention has three sides surrounded by the ground, and only one side of the clearance is open. However, the clearance 800 of the antenna according to the eighth embodiment of the present invention is formed to have all four sides surrounded by the ground 80.

As described above, each of the second, fourth, and seventh embodiments of the present invention belongs to an antenna group having the same basic connection. However, depending upon the shape of the clearance, depending upon whether or not a portion of the antenna or the entire antenna is formed in the clearance, and depending upon whether or not the antenna is formed outside of the clearance, each of the second, fourth, and seventh embodiments may be formed to have a different shape. Therefore, for each identical antenna group, by creating a clearance having two sides surrounded by the ground and two sides open to the outside, and by applying this structure to each embodiment of the present invention, the antenna may be formed to have a wide range of shapes other than the shapes shown in the drawings.

Therefore, the clearance having two sides open to the outside may also be applied to the third, fifth, sixth, and eighth embodiments of the present invention, each belonging to the same antenna group.

1. A ground radiation antenna, comprising:
a ground configured on a printed circuit board of a wireless communication terminal;
a circuit part connected to the ground and configured of an element, a capacitive element, and a conductor line connecting the element and the capacitive element; and
a feeding part connected to the circuit part and the ground so as to feed an RF signal.

2. The ground radiation antenna of claim 1, wherein the element corresponds to any one of an inductive element, a capacitive element, and a conductor line.

3. The ground radiation antenna of claim 1, wherein the circuit part operates as an antenna radiator-forming circuit, and wherein the circuit part also operates as a feeding circuit.

4. The ground radiation antenna of claim 1, wherein the capacitive element corresponds to a lumped circuit element.

5. The ground radiation antenna of claim 4, wherein the lumped circuit element corresponds to a chip capacitor.

6. The ground radiation antenna of claim 1, wherein the capacitive element corresponds to a capacitor having a general capacitive structure.

7. A ground radiation antenna, comprising:
a ground configured on a printed circuit board of a wireless communication terminal;
a circuit part connected to the ground and configured of a first element, a capacitive element, and a conductor line connecting the first element and the capacitive element;
a feeding part connected to the circuit part and the ground so as to feed an RF signal; and
an impedance matching part including a second element, wherein the second element is inter-connected with the first element, the capacitive element, and the ground.

8. The ground radiation antenna of claim 7, wherein the first element corresponds to any one of an inductive element, a capacitive element, and a conductor line.

9. The ground radiation antenna of claim 7, wherein the second element corresponds to any one of an inductive element and a conductor line.

10. The ground radiation antenna of claim 7, wherein the capacitive element corresponds to a lumped circuit element.

11. The ground radiation antenna of claim 10, wherein the lumped circuit element corresponds to a chip capacitor.

12. The ground radiation antenna of claim 7, wherein the capacitive element corresponds to a capacitor having a general capacitive structure.

13. The ground radiation antenna of claim 7, wherein the circuit part and the impedance matching part are located inside a clearance.

14. The ground radiation antenna of claim 13, wherein the clearance has one open side.

15. The ground radiation antenna of claim 13, wherein the clearance is surrounded by the ground.

16. The ground radiation antenna of claim 13, wherein the clearance has two open sides.

17. The ground radiation antenna of claim 7, wherein the circuit part and the radiator-forming circuit are formed to be protruded outside of the ground.

18. A ground radiation antenna, comprising:
a ground configured on a printed circuit board of a wireless communication terminal;
a first circuit part connected to the ground and configured of a feeding part, a first element, a first capacitive element, and a conductor line connecting the feeding part, the first element, and the first capacitive element;
a second circuit part connected to the ground and configured of the feeding part, the first element, a second capacitive element, and a conductor line connecting the feeding part, the first element, and the second capacitive element; and
an impedance matching part configured to connect the first element, the first capacitance element, and the second capacitance element to the ground, and
wherein the first circuit part and the second circuit part correspond to feeding circuits operating as radiator-forming circuits.

19. The ground radiation antenna of claim 18, wherein the first element corresponds to any one of an inductive element, a capacitive element, and a conductor line.

20. The ground radiation antenna of claim 18, wherein the second element corresponds to any one of an inductive element and a conductor line.

21. The ground radiation antenna of claim 18, wherein the first capacitive element and the second capacitive element correspond to lumped circuit elements.

22. The ground radiation antenna of claim 18, wherein the first circuit part, the second circuit part, and the impedance matching part are located inside a clearance.

23. The ground radiation antenna of claim 22, wherein the clearance has one open side.

24. The ground radiation antenna of claim 22, wherein the clearance is surrounded by the ground.

25. The ground radiation antenna of claim 22, wherein the clearance has two open sides.

26. The ground radiation antenna of claim 18, wherein the first circuit part, the second circuit part, and the impedance matching part are formed to be protruded outside of the ground.
